(19) United States
(12) Patent Application Publication
(10) Pub. No.: US 2019/0150045 A1
(43) Pub. Date: May 16, 2019

(54) HANDOVER METHOD AND APPARATUS

(71) Applicant: HUAWEI TECHNOLOGIES CO., LTD., Shenzhen (CN)

(72) Inventors: He LI, Shanghai (CN); Jing CHEN, Shanghai (CN)

(21) Appl. No.: 16/247,228

(22) Filed: Jan. 14, 2019

Related U.S. Application Data
(63) Continuation of application No. PCT/CN2016/090233, filed on Jul. 15, 2016.

(51) Int. Cl. H04W 36/08; H04W 36/00

(52) U.S. Cl. CPC H04W 36/08; H04W 36/0058; H04W 36/0069

(57) ABSTRACT

The present invention provides a handover method and apparatus. A source base station sends a handover request message to a target base station. After receiving the handover request message, the target base station determines, based on first indication information, that user equipment is using a first connection, and determines to instruct the source base station to maintain the first connection. Therefore, a handover request acknowledgment message is sent to the source base station, and the first connection is maintained, so as to reduce an impact on continuity of data transmission in a handover process.

### CROSS-REFERENCE TO RELATED APPLICATIONS

This application is a continuation of International Application No. PCT/CN2016/090233, filed on Jul. 15, 2016, the disclosure of which is hereby incorporated by reference in its entirety.

### TECHNICAL FIELD

Embodiments of the present invention relate to the communications technologies, and in particular, to a handover method and apparatus.

### BACKGROUND

A Long Term Evolution wireless local area network aggregation (LWA) is a technology in which a wireless local area network (WLAN) technology is applied to a Long Term Evolution (LTE) network.

In an existing LWA technology, an access procedure of user equipment (UE) is as follows: A base station sets a wireless local area network termination (WT) counter value to 0, and generates a key S-Kwt using a KeNB shared by the user equipment and the base station and the WT counter value; an eNB sends a WT addition request message to a WT, where the WT addition request message carries the S-Kwt, a mobility set, and a Medium Access Control (MAC) address of the user equipment; the WT delivers the S-Kwt to all access points in the mobility set, so that the access point may learn a key used by the user equipment that is to access a wireless network; the WT sends a WT addition request acknowledgment message to the base station; the base station sends a radio resource control (RRC) connection reconfiguration message to the user equipment, where the message carries the mobility set and the WT counter value required for generating the S-Kwt; the user equipment generates the key S-Kwt based on the WT counter value and the S-Kwt of the KeNB shared by the user equipment and the base station; the user equipment sends an RRC connection reconfiguration complete message to the base station, and the user equipment starts to be associated with the access point in the mobility set, and accesses the wireless network; after the user equipment accesses the wireless network, the access point sends a notification message to the WT, to notify the user equipment of access success; and the WT sends a WT association acknowledgment message to the user equipment, to complete establishment of an LWA link.

However, when the user equipment needs to be handed over from one base station to another base station, according to a prior-art method, the user equipment needs to first disconnect an LWA link from an original base station, and then establish an LWA link to a new base station. In the handover process, because the LWA link is disconnected, continuity of data transmission is affected.

### SUMMARY

Embodiments of the present invention provide a handover method and apparatus, so as to reduce an impact on continuity of data transmission in a handover process.

According to a first aspect, an embodiment of the present invention provides a handover method. A source base station sends a handover request message to a target base station, where the handover request message includes first indication information, and the first indication information is used to indicate that user equipment is using a first connection. After receiving the handover request message, the target base station determines, based on the first indication information, that the user equipment is using the first connection, and determines to instruct the source base station to maintain the first connection. Therefore, a handover request acknowledgment message is sent to the source base station, and the handover acknowledgment message includes second indication information that is used to indicate that the first connection is maintained. Therefore, in a handover process, the first connection is maintained, so as to reduce an impact on continuity of data transmission in the handover process.

In a possible embodiment, the first indication information includes an identifier of the user equipment and a first mobility set, and the first mobility set includes an identifier of at least one first access point.

In a possible embodiment, the first indication information includes an identifier indicating that the user equipment is using the first connection.

In a possible embodiment, the second indication information includes an identifier indicating that the first connection is maintained.

In a possible embodiment, the second indication information includes the identifier of the user equipment and the first mobility set.

In a possible embodiment, the identifier of the user equipment includes a Medium Access Control address.

In a possible embodiment, the first connection is a Long Term Evolution wireless local area network aggregation connection.

In a possible embodiment, before the sending a handover request acknowledgment message to the source base station, the method further includes:

obtaining a first key.

In a possible embodiment, after the sending a handover request acknowledgment message to the source base station, the method further includes:

obtaining a first key.

In a possible embodiment, after the sending a handover request acknowledgment message to the source base station, the method further includes:

obtaining a third mobility set of the user equipment, where the third mobility set is determined based on a measurement report of the user equipment, and the third mobility set includes an identifier of at least one third access point.

In a possible embodiment, before the sending a handover request acknowledgment message to the source base station, the method further includes:

obtaining a third mobility set of the user equipment.

In a possible embodiment, the obtaining a first key includes:

generating the first key based on a second key and a WT counter value that are shared by the target base station and the user equipment.

In a possible embodiment, the obtaining a third mobility set of the user equipment includes:

obtaining the third mobility set of the user equipment based on a measurement report of the user equipment.

In a possible embodiment, before the sending a handover request acknowledgment message to the source base station, the method further includes:

sending a first request message to a WT, where the first request message includes third indication information, and the third indication information is used to indicate whether the WT maintains the first connection.

In a possible embodiment, the method further includes:

sending a second request message to the WT, where the second request message includes the first key and the third mobility set;

receiving a second request acknowledgment message sent by the WT;

sending a radio resource control RRC connection reconfiguration message to the user equipment, where the message carries the third mobility set and a parameter used to generate the first key; and receiving an RRC connection reconfiguration complete message sent by the user equipment.

In a possible embodiment, the method further includes:

sending a third request message to the WT, where the third request message includes a first key and a third mobility set, and the third mobility set includes an identifier of at least one third access point;

receiving a third request acknowledgment message sent by the WT;

sending an RRC connection reconfiguration message to the user equipment, where the message carries the third mobility set and a parameter used to generate the first key; and

receiving an RRC connection reconfiguration complete message sent by the user equipment.

In a possible embodiment, before the sending an RRC connection reconfiguration message to the user equipment, the method further includes:

sending a path handover request message to a mobility management entity MME; and

receiving a path handover request acknowledgment message sent by the MME.

In a possible embodiment, before the obtaining a third mobility set of the user equipment, the method further includes:

sending a path handover request message to a mobility management entity MME; and

receiving a path handover request acknowledgment message sent by the MME.

In a possible embodiment, before the obtaining a third mobility set of the user equipment, the method further includes:

receiving a handover determining message sent by the user equipment; and

sending a path handover request message to a mobility management entity MME; and

after the receiving a second request acknowledgment message sent by the WT, and before the sending an RRC connection reconfiguration message to the user equipment, the method further includes:

receiving a path handover request acknowledgment message sent by the MME.

In a possible design, the obtaining a first key includes:

receiving the first key sent by the source base station.

In a possible embodiment, the handover request message further includes the measurement report of the user equipment

In a possible embodiment, the handover request message further includes an identifier of a fourth access point to which the user equipment is currently connected.

In a possible embodiment, the third mobility set includes the identifier of the fourth access point; or

the third mobility set does not include the identifier of the fourth access point.

In a possible embodiment, the handover request message further includes a third mobility set; and

the obtaining a third mobility set of the user equipment includes:

obtaining the third mobility set of the user equipment from the handover request message.

In a possible embodiment, the obtaining a first key includes:

generating the first key based on a second key, a WT counter value, and private information that are shared by the target base station and the user equipment.

In a possible embodiment, the obtaining a first key includes:

receiving an initial key sent by the source base station; and

generating the first key based on the initial key and private information.

In a possible embodiment, the third indication information includes the identifier of the user equipment and a second mobility set.

In a possible embodiment, the third indication information includes an identifier indicating that the first connection is maintained.

According to a second aspect, an embodiment of the present invention provides a handover method, including: sending a handover request message to a target base station, where the handover request message includes first indication information, and the first indication information is used to indicate that user equipment is using a first connection; and

receiving a handover request acknowledgment message sent by the target base station, where the handover request acknowledgment message includes second indication information, and the second indication information is used to indicate that the first connection is maintained.

In a possible embodiment, the first indication information includes an identifier of the user equipment and a first mobility set, and the first mobility set includes an identifier of at least one first access point.

In a possible embodiment, the first indication information includes an identifier indicating that the user equipment is using the first connection.

In a possible embodiment, the second indication information includes an identifier indicating that the first connection is maintained.

In a possible embodiment, the second indication information includes the identifier of the user equipment and the first mobility set.

In a possible embodiment, the identifier of the user equipment is a Medium Access Control address.

In a possible embodiment, the first connection is a Long Term Evolution wireless local area network aggregation connection.

In a possible embodiment, the method further includes:

sending a measurement report of the user equipment to the target base station.

In a possible embodiment, the handover request message further includes a third mobility set; and

before the sending a handover request message to a target base station, the method further includes:

generating the third mobility set based on a measurement report of the user equipment.

According to a third aspect, an embodiment of the present invention provides a handover method, including: receiving a first request message sent by a target base station, where the first request message includes third indication information, and the third indication information is used to indicate whether a WT maintains a first connection; and

determining, based on the third indication information, whether to maintain the first connection.

In a possible embodiment, the third indication information includes an identifier of user equipment and a second mobility set, and the second mobility set includes an identifier of at least one second access point.

In a possible embodiment, the third indication information includes an identifier indicating that the first connection is maintained.

In a possible embodiment, the determining, based on the third indication information, whether to maintain the first connection includes:

if the second mobility set is the same as a first mobility set, determining to maintain the first connection, where the first mobility set includes an identifier of at least one first access point.

In a possible embodiment, after the determining to maintain the first connection, the method further includes:

receiving a third request message sent by the target base station, where the third request message includes a first key and a third mobility set, and the third mobility set includes an identifier of at least one third access point;

determining whether the third mobility set is the same as the first mobility set;

if the third mobility set is different from the first mobility set, sending the first key to all third access points in the third mobility set; and

sending a third request acknowledgment message to the target base station.

According to a fourth aspect, an embodiment of the present invention provides a handover apparatus, including: a receiver, configured to receive a handover request message sent by a source base station, where the handover request message includes first indication information, and the first indication information is used to indicate that user equipment is using a first connection; and

a transmitter, configured to send a handover request acknowledgment message to the source base station, where the handover request acknowledgment message includes second indication information, and the second indication information is used to indicate that the first connection is maintained.

In a possible embodiment, the first indication information includes an identifier of the user equipment and a first mobility set, and the first mobility set includes an identifier of at least one first access point.

In a possible embodiment, the first indication information includes an identifier indicating that the user equipment is using the first connection.

In a possible embodiment, the second indication information includes an identifier indicating that the first connection is maintained.

In a possible embodiment, the second indication information includes the identifier of the user equipment and the first mobility set.

In a possible embodiment, the identifier of the user equipment is a Medium Access Control address.

In a possible embodiment, the first connection is a Long Term Evolution wireless local area network aggregation connection.

In a possible embodiment, the apparatus further includes:

a processor, configured to obtain a first key.

In a possible design, the apparatus further includes:

a processor, configured to obtain a first key.

In a possible embodiment, the processor is further configured to obtain a third mobility set of the user equipment, where the third mobility set is determined based on a measurement report of the user equipment, and the third mobility set includes an identifier of at least one third access point.

In a possible embodiment, the processor is configured to generate the first key based on a second key and a WT counter value that are shared by the target base station and the user equipment.

In a possible embodiment, the processor is configured to:

obtain the third mobility set of the user equipment based on a measurement report of the user equipment.

In a possible embodiment, the transmitter is further configured to send a first request message to a WT, where the first request message includes third indication information, and the third indication information is used to indicate whether the WT maintains the first connection.

In a possible embodiment, the transmitter is further configured to send a second request message to the WT, where the second request message includes the first key and the third mobility set;

the receiver is further configured to receive a second request acknowledgment message sent by the WT;

the transmitter is further configured to send a radio resource control RRC connection reconfiguration message to the user equipment, where the message carries the third mobility set and a parameter used to generate the first key; and

the receiver is further configured to receive an RRC connection reconfiguration complete message sent by the user equipment.

In a possible embodiment, the transmitter is further configured to send a third request message to the WT, where the third request message includes a first key and a third mobility set, and the third mobility set includes an identifier of at least one third access point;

the receiver is further configured to receive a third request acknowledgment message sent by the WT;

the transmitter is further configured to send an RRC connection reconfiguration message to the user equipment, where the message carries the third mobility set and a parameter used to generate the first key; and

the receiver is further configured to receive an RRC connection reconfiguration complete message sent by the user equipment.

In a possible embodiment, the transmitter is further configured to send a path handover request message to a mobility management entity MME; and

the receiver is further configured to receive a path handover request acknowledgment message sent by the MME.

In a possible embodiment, the transmitter is further configured to send a path handover request message to a mobility management entity MME; and

the receiver is further configured to receive a path handover request acknowledgment message sent by the MME.

In a possible embodiment, the receiver is further configured to receive a handover determining message sent by the user equipment;

the transmitter is further configured to send a path handover request message to a mobility management entity MME; and

the receiver is further configured to receive a path handover request acknowledgment message sent by the MME.

In a possible embodiment, the processor is configured to control the receiver to receive the first key sent by the source base station.

In a possible embodiment, the handover request message further includes the measurement report of the user equipment.

In a possible embodiment, the handover request message further includes an identifier of a fourth access point to which the user equipment is currently connected.

In a possible embodiment, the third mobility set includes the identifier of the fourth access point; or

the third mobility set does not include the identifier of the fourth access point.

In a possible embodiment, the handover request message further includes a third mobility set; and

the processor is configured to obtain the third mobility set of the user equipment from the handover request message.

In a possible embodiment, the processor is configured to generate the first key based on a second key, a WT counter value, and private information that are shared by the target base station and the user equipment.

In a possible embodiment, the processor is configured to: control the receiver to receive an initial key sent by the source base station, and generate the first key based on the initial key and private information.

In a possible embodiment, the third indication information includes an identifier of user equipment and a second mobility set.

In a possible embodiment, the third indication information includes an identifier indicating that the first connection is maintained.

According to a fifth aspect, an embodiment of the present invention provides a handover apparatus, including: a transmitter, configured to send a handover request message to a target base station, where the handover request message includes first indication information, and the first indication information is used to indicate that user equipment is using a first connection; and

a receiver, configured to receive a handover request acknowledgment message sent by the target base station, where the handover request acknowledgment message includes second indication information, and the second indication information is used to indicate that the first connection is maintained.

In a possible embodiment, the first indication information includes an identifier of the user equipment and a first mobility set, and the first mobility set includes an identifier of at least one first access point.

In a possible embodiment, the first indication information includes an identifier indicating that the user equipment is using the first connection.

In a possible embodiment, the second indication information includes an identifier indicating that the first connection is maintained.

In a possible embodiment, the second indication information includes the identifier of the user equipment and the first mobility set.

In a possible embodiment, the identifier of the user equipment is a Medium Access Control address.

In a possible embodiment, the first connection is a Long Term Evolution wireless local area network aggregation connection.

In a possible embodiment, the transmitter is further configured to send a measurement report of the user equipment to the target base station.

In a possible embodiment, the handover request message further includes a third mobility set; and

the apparatus further includes:

a processor, configured to generate the third mobility set based on a measurement report of the user equipment.

According to a sixth aspect, an embodiment of the present invention provides a handover apparatus, including: a receiver, configured to receive a first request message sent by a target base station, where the first request message includes third indication information, and the third indication information is used to indicate whether the WT maintains the first connection; and

a processor, configured to determine, based on the third indication information, whether to maintain the first connection.

In a possible embodiment, the third indication information includes an identifier of user equipment and a second mobility set, and the second mobility set includes an identifier of at least one second access point.

In a possible embodiment, the third indication information includes an identifier indicating that the first connection is maintained.

In a possible embodiment, the processor is configured to: if the second mobility set is the same as a first mobility set, determine to maintain the first connection, where the first mobility set includes an identifier of at least one first access point.

In a possible embodiment, the receiver is further configured to receive a third request message sent by the target base station, where the third request message includes a first key and a third mobility set, and the third mobility set includes an identifier of at least one third access point;

the processor is further configured to determine whether the third mobility set is the same as the first mobility set; and

the apparatus further includes:

a transmitter, configured to: if the third mobility set is different from the first mobility set, send the first key to all third access points in the third mobility set; and

the transmitter is further configured to send a third request acknowledgment message to the target base station.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and persons of ordinary skill in the art may derive other drawings from these accompanying drawings without creative efforts.

FIG. 1 is a diagram of a scenario architecture according to an embodiment of the present invention;

FIG. 2 is a schematic flowchart of Embodiment 1 of a handover method according to the present invention;

FIG. 3 is a schematic flowchart of Embodiment 2 of a handover method according to the present invention;

FIG. 4 is a schematic flowchart of Embodiment 3 of a handover method according to the present invention;

FIG. 5 is a schematic flowchart of Embodiment 4 of a handover method according to the present invention;

FIG. 6 is a schematic flowchart of Embodiment 5 of a handover method according to the present invention;

FIG. 7 is a schematic flowchart of Embodiment 6 of a handover method according to the present invention;

FIG. 8 is a schematic flowchart of Embodiment 7 of a handover method according to the present invention;

FIG. 9 is a schematic flowchart of Embodiment 8 of a handover method according to the present invention;

FIG. 10 is a schematic flowchart of Embodiment 9 of a handover method according to the present invention;

FIG. 11 is a schematic flowchart of Embodiment 10 of a handover method according to the present invention;

FIG. 12 is a schematic flowchart of Embodiment 11 of a handover method according to the present invention;

FIG. 13 is a schematic flowchart of Embodiment 13 of a handover method according to the present invention;

FIG. 14 is a schematic structural diagram of Embodiment 1 of a handover apparatus according to the present invention;

FIG. 15 is a schematic structural diagram of Embodiment 2 of a handover apparatus according to the present invention; and

FIG. 16 is a schematic structural diagram of Embodiment 3 of a handover apparatus according to the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by persons of ordinary skill in the art based on the embodiments of the present invention without creative efforts shall fall within the protection scope of the present invention.

In the specification, claims, and accompanying drawings of the present invention, the terms “first”, “second”, “third”, “fourth”, and so on (if any) are intended to distinguish between similar objects but do not necessarily indicate a specific order or sequence. It should be understood that the data termed in such a way are interchangeable in proper circumstances so that the embodiments of the present invention described herein can be implemented in orders except the order illustrated or described herein. Moreover, the terms “include”, “contain” and any other variants mean to cover the non-exclusive inclusion, for example, a process, method, system, product, or device that includes a list of operations or units is not necessarily limited to those units, but may include other units not expressly listed or inherent to such a process, method, system, product, or device.

The following embodiments of the present invention are applicable to different wireless communications systems, such as a Global System for Mobile Communications (GSM), a Universal Mobile Telecommunications System (UMTS), and a scenario in which a future telecommunications system and a WLAN are aggregated.

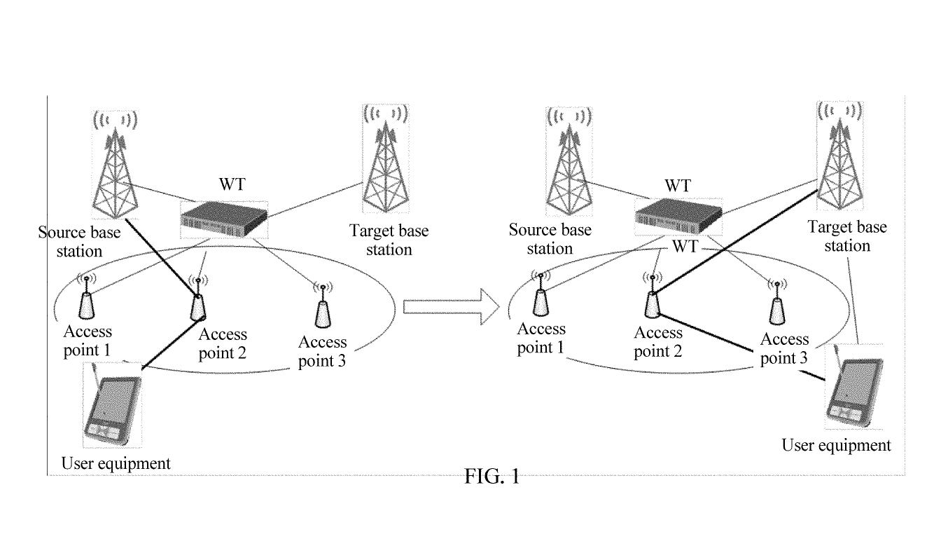

FIG. 1 is a diagram of a scenario architecture according to an embodiment of the present invention. As shown in FIG. 1, the scenario includes a source base station, a target base station, a WT, an access point, and user equipment. The source base station and the target base station are corresponding to different base stations in different wireless communications systems, for example, corresponding to eNBs in an LTE system. In the scenario, the user equipment is handed over from the source base station to the target base station, the user equipment and the source base station exchange information by using the access point (represented by an access point 2 in FIG. 1) and the WT, and the user equipment and the target base station exchange information by using the access point (represented by the access point 2 in FIG. 1) and the WT.

In the following embodiments of the present invention, a connection that is between the user equipment and the source base station and that is used to exchange information by using the access point and the WT is referred to as a first connection.

In the present invention, a handover request message sent by the source base station to the target base station carries a first indication message that is used to indicate that the user equipment is using the first connection, and the target base station receives the handover request message sent by the source base station. Because the first indication message carries the first indication message indicating that the user equipment is using the first connection, in a handover process, the source base station maintains the first connection, so as to reduce an impact on continuity of data transmission in the handover process.

“An identifier of user equipment” described in the following embodiments of the present invention may be a Medium Access Control address, another identifier that can be used to distinguish between user equipments, or the like. This is not limited in the present invention.

The “first connection” may be a Long Term Evolution wireless local area network aggregation (LWA) connection or another similar connection. This is not limited in the present invention.

Specific embodiments are used below to describe in detail the technical solutions of the present invention. The following several specific embodiments may be combined with each other, and a same or similar concept or process may not be described repeatedly in some embodiments.

### Embodiment 1

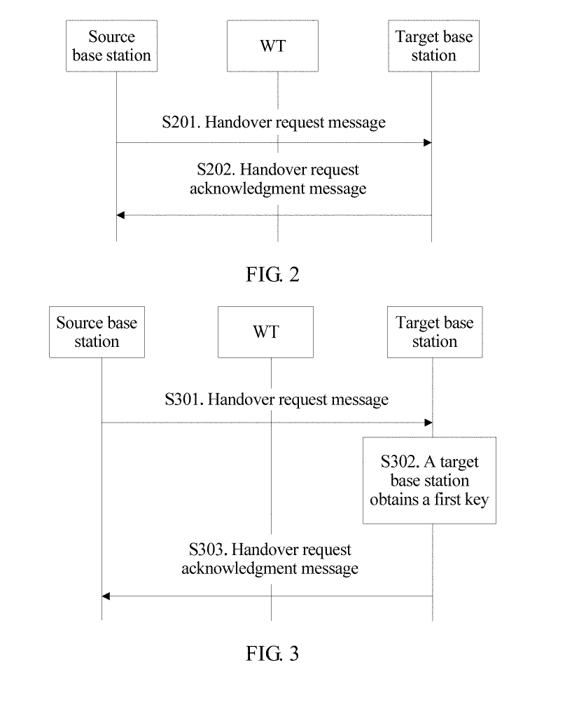

FIG. 2 is a schematic flowchart of Embodiment 1 of a handover method according to the present invention. As shown in FIG. 2, the method in this embodiment is as follows.

Operation S201. A source base station sends a handover request message to a target base station.

The handover request message includes first indication information, and the first indication information is used to indicate that user equipment is using a first connection.

The first indication information includes but is not limited to the following two possible implementations.

In one possible implementation,

the first indication information is an identifier of the user equipment and a first mobility set, and the first mobility set includes an identifier of at least one first access point.

In the other possible implementation,

the first indication information is an identifier indicating that the user equipment is using the first connection.

The identifier may be a number, a letter, or a combination of a number and a letter. For example, a bit or several bits of the handover request message may be defined to set the first indication information. For example, when a bit is defined as 0, it indicates that the first connection is not being used; and when a bit is defined as 1, it indicates that the user equipment is using the first connection. Alternatively, the first indication information is represented by a letter. For example, a letter “A” represents that the user equipment is not using the first connection, or a letter “B” represents that the user equipment is using the first connection. This is not limited in the present invention, provided that a case in which the user equipment is using the first connection can be indicated.

Operation S202. The target base station sends a handover request acknowledgment message to the source base station.

The handover request acknowledgment message includes second indication information, and the second indication information is used to indicate that the first connection is maintained.

After receiving the handover request message sent by the source base station, the target base station parses the handover request message, and the handover request message includes the first indication information that is used to indicate that the user equipment is using the first connection. The target base station determines, based on the first indication information, that the user equipment is using the first connection, and determines to instruct the source base station to maintain the first connection. Therefore, the handover request acknowledgment message is sent to the source base station, and the handover acknowledgment message includes the second indication information that is used to indicate that the first connection is maintained.

The source base station receives the handover request acknowledgment message sent by the target base station, where the handover request acknowledgment message includes the second indication information, and the second indication information is used to indicate that the first connection is maintained. The source base station determines, based on the second indication information, to maintain the first connection.

The second indication information includes but is not limited to the following two possible implementations.

In one possible implementation,

the first indication information is the identifier of the user equipment and the first mobility set, and the first mobility set includes the identifier of the at least one first access point.

In the other possible implementation,

the first indication information is an identifier indicating that the first connection is maintained.

The identifier may be a number, a letter, or a combination of a number and a letter. For example, a bit or several bits of the handover request acknowledgment message may be defined to set the second indication information. For example, when a bit is defined as 0, it indicates that the first connection is maintained; and when a bit is defined as 1, it indicates that the first connection is released. Alternatively, the second indication information is represented by a letter. For example, a letter “A” represents that the first connection is maintained, or a letter “B” represents that the first connection is released. This is not limited in the present invention, provided that a case in which the first connection is maintained is indicated.

In this embodiment, the source base station sends the handover request message to the target base station, where the handover request message includes the first indication information, and the first indication information is used to indicate that the user equipment is using the first connection. After receiving the handover request message, the target base station determines, based on the first indication information, that the user equipment is using the first connection, and determines to instruct the source base station to maintain the first connection. Therefore, the handover request acknowledgment message is sent to the source base station, and the handover acknowledgment message includes the second indication information that is used to indicate that the first connection is maintained. Therefore, in a handover process, the first connection is maintained, so as to reduce an impact on continuity of data transmission in the handover process.

### Embodiment 2

FIG. 3 is a schematic flowchart of Embodiment 2 of a handover method according to the present invention. Embodiment 2 is based on Embodiment 1. Before the target base station sends the handover request acknowledgment message to the source base station, the method further includes: The target base station obtains a first key. As shown in FIG. 3, the method in this embodiment is as follows.

Operation S301. The source base station sends the handover request message to the target base station.

For detailed description of this operation, refer to operation S201 in the embodiment shown in FIG. 2. Details are not described herein again.

Operation S302. The target base station obtains the first key.

The first key may be S-Kwt, and the first key is generated based on a second key and a WT counter value that are shared by the target base station and the user equipment.

A manner of obtaining the first key includes but is not limited to the following possible implementations.

In a possible implementation, the target base station generates the first key based on the second key and the WT counter value that are shared by the target base station and the user equipment.

The second key may be K-eNB.

In another possible implementation,

the target base station receives the first key sent by the source base station.

To be specific, the source base station generates the first key, and sends the first key to the target base station. Therefore, the target base station may directly obtain the first key from the source base station instead of generating the first key.

In still another possible implementation,

the first key is generated based on a second key, a WT counter value, and private information that are shared by the target base station and the user equipment.

To improve security of the first key, the target base station generates the first key based on the second key, the WT counter value, and the private information, and sends the private information to the user equipment. Therefore, a first key of the source base station is isolated from the first key of the target base station, so as to reduce a possibility that the target base station is attacked when the source base station is attacked.

In still yet another possible implementation,

the target base station receives an initial key sent by the source base station, and generates the first key based on the initial key and private information.

To be specific, the source base station generates the initial key based on a second key and a WT counter value, and sends the initial key to the target base station. The target base station further generates the first key based on the initial key and the private information. Therefore, security of the first key is improved, and a first key of the source base station is isolated from the first key of the target base station, so as to reduce a possibility that the target base station is attacked when the source base station is attacked.

In the foregoing possible implementations, the private information may be implemented by using a random number.

Operation S303. The target base station sends the handover request acknowledgment message to the source base station.

For detailed description of this operation, refer to operation S202 in the embodiment shown in FIG. 2. Details are not described herein again.

### Embodiment 3

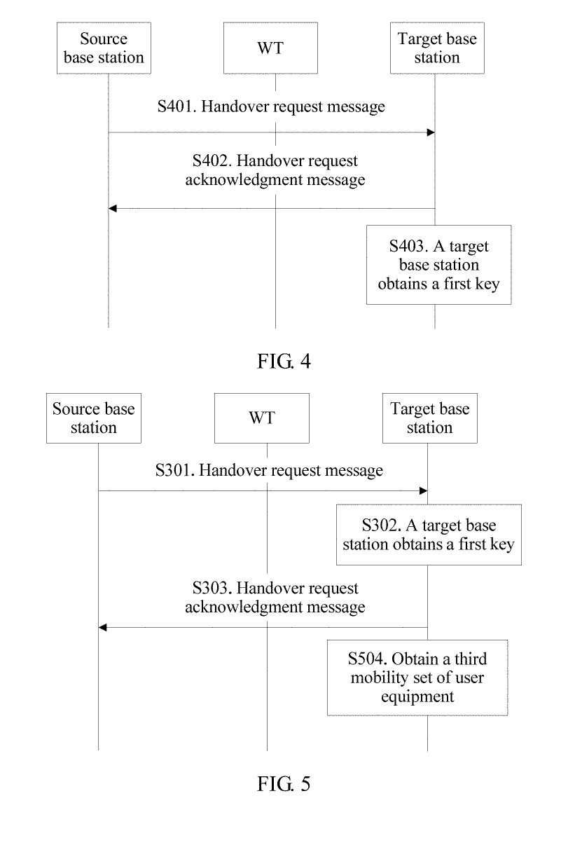

A difference between Embodiment 3 and Embodiment 2 lies in an execution sequence of the operations corresponding to S302 and S303. In Embodiment 2, the operation corresponding to S302 is performed before the operation corresponding to S303. In Embodiment 3, the operation corresponding to operation S302 is performed after the operation corresponding to operation S303. FIG. 4 is a schematic flowchart of Embodiment 3 of a handover method according to the present invention, including the following operations.

Operation S401. The source base station sends the handover request message to the target base station.

For detailed description of this operation, refer to operation S201 in the embodiment shown in FIG. 2. Details are not described herein again.

Operation S402. The target base station sends the handover request acknowledgment message to the source base station.

For detailed description of this operation, refer to operation S202 in the embodiment shown in FIG. 2. Details are not described herein again.

Operation S403. The target base station obtains a first key.

For detailed description of this operation, refer to operation S302 in the embodiment shown in FIG. 3. Details are not described herein again.

### Embodiment 4 and Embodiment 5

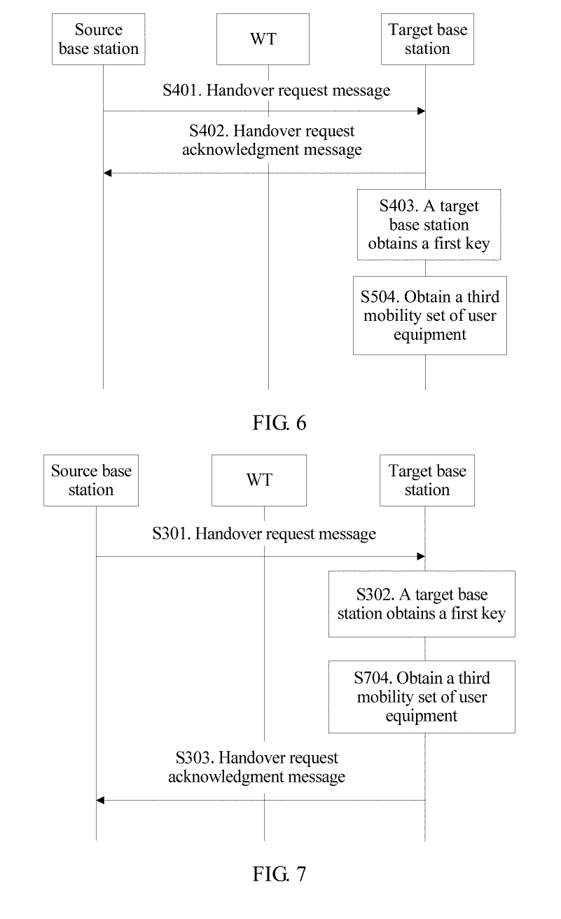

Embodiment 4 is based on the embodiment shown in Embodiment 2 or Embodiment 3. FIG. 5 is a schematic flowchart of Embodiment 4 of a handover method according to the present invention, and FIG. 6 is a schematic flowchart of Embodiment 5 of a handover method according to the present invention. FIG. 5 is based on the embodiment shown in FIG. 3, and FIG. 6 is based on the embodiment shown in FIG. 4. After the target base station sends the handover request acknowledgment message to the source base station, the method further includes:

Operation S504. The target base station obtains a third mobility set of the user equipment.

The third mobility set is determined based on a measurement report of the user equipment, and the third mobility set includes an identifier of at least one third access point.

A manner of obtaining the third mobility set of the user equipment includes but is not limited to the following implementations.

In a possible implementation,

the target base station obtains the third mobility set of the user equipment based on the measurement report of the user equipment.

A possible manner of obtaining the measurement report is that the source base station may add the measurement report to a handover request, and send the handover request to the target base station, so that the target base station may obtain the measurement report from the handover request.

Another possible manner of obtaining the measurement report is that the target base station receives the measurement report sent by the user equipment.

In another possible implementation,

the source base station generates the third mobility set based on the measurement report of the user equipment, and adds the third mobility set to a handover request, and the target base station obtains the third mobility set of the user equipment from the handover request message.

### Embodiment 6 and Embodiment 7

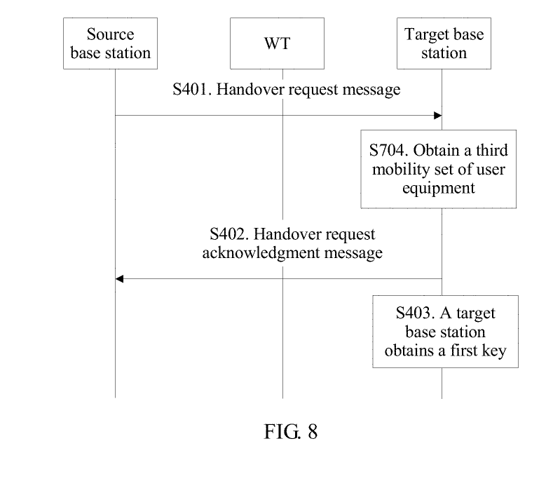

Embodiment 5 is based on the embodiment shown in Embodiment 2 or Embodiment 3. FIG. 7 is a schematic flowchart of Embodiment 6 of a handover method according to the present invention, and FIG. 8 is a schematic flowchart of Embodiment 7 of a handover method according to the present invention. FIG. 7 is based on the embodiment shown in FIG. 3, and FIG. 8 is based on the embodiment shown in FIG. 4. Before the target base station sends the handover request acknowledgment message to the source base station, the method further includes:

Operation S704. The target base station obtains a third mobility set of the user equipment.

The third mobility set is determined based on a measurement report of the user equipment, and the third mobility set includes an identifier of at least one third access point.

A manner of obtaining the third mobility set of the user equipment includes but is not limited to the following implementations.

In a possible implementation,

the target base station obtains the third mobility set of the user equipment based on the measurement report of the user equipment.

A possible manner of obtaining the measurement report is that the source base station may add the measurement report to a handover request, and send the handover request to the target base station, so that the target base station may obtain the measurement report from the handover request.

In another possible implementation,

the source base station generates the third mobility set based on the measurement report of the user equipment, and adds the third mobility set to a handover request, and the target base station obtains the third mobility set of the user equipment from the handover request message.

### Embodiment 8

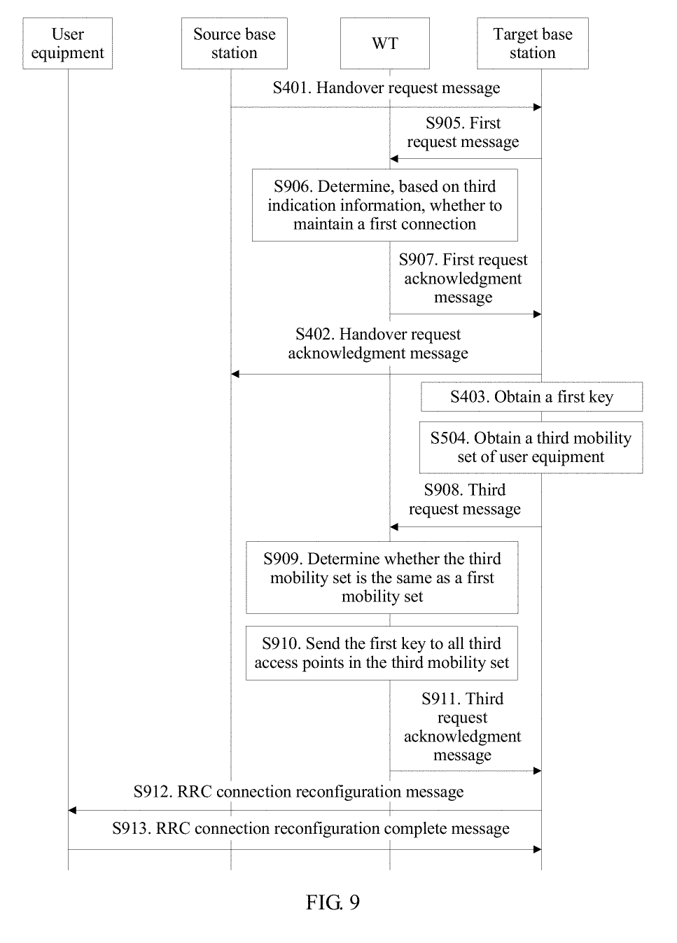

Embodiment 8 is based on the foregoing embodiments. Before the target base station sends the handover request acknowledgment message to the source base station, the method further includes S905 to S907. For example, based on the embodiment shown in FIG. 6, FIG. 9 is a schematic flowchart of Embodiment 8 of a handover method according to the present invention.

Operation S905. The target base station sends a first request message to a WT.

The first request message includes third indication information, and the third indication information is used to indicate whether the WT maintains the first connection.

The third indication information includes but is not limited to the following two possible implementations.

In one possible implementation,

the third indication information includes the identifier of the user equipment and a second mobility set, and the second mobility set includes an identifier of at least one second access point.

In the other possible implementation,

the third indication information is an identifier indicating that the first connection is maintained.

The identifier may be a number, a letter, or a combination of a number and a letter. For example, a bit or several bits of the first request message may be defined to set the third indication information. For example, when a bit is defined as 0, it indicates that the first connection is maintained; and when a bit is defined as 1, it indicates that the first connection is released. Alternatively, the third indication information is represented by a letter. For example, a letter “A” represents that the first connection is maintained, and a letter “B” represents that the first connection is released. This is not limited in the present invention, provided that a case in which the first connection is maintained is indicated.

The first request message may be a first WT addition request message.

Operation S906. The WT determines, based on third indication information, whether to maintain the first connection.

The WT receives the first request message sent by the target base station, and obtains the third indication information. When the third indication information includes the identifier of the user equipment and the second mobility set, the WT determines whether the second mobility set is the same as the first mobility set. If the second mobility set is the same as the first mobility set, the WT determines to maintain the first connection.

When the third indication information is the identifier indicating that the first connection is maintained, the WT determines to maintain the first connection.

Operation S907. The WT sends a first request acknowledgment message to the target base station.

In one embodiment, the first request acknowledgment message further includes fourth indication information, and the fourth indication information is used to instruct the WT to maintain the first connection.

The fourth indication information may be an identifier indicating that the WT maintains the first connection. The identifier may be a number, a letter, or a combination of a number and a letter. For example, a bit or several bits of the first request acknowledgment message may be defined to set the fourth indication information. For example, when a bit is defined as 0, it indicates that the WT maintains the first connection; and when a bit is defined as 1, it indicates that the WT releases the first connection. Alternatively, the fourth indication information is represented by a letter. For example, a letter “A” represents that the WT maintains the first connection, and a letter “B” represents that the WT releases the first connection. This is not limited in the present invention, provided that a case in which the WT maintains the first connection is indicated.

Optionally, after the target base station sends the handover request acknowledgment message to the source base station, the method may further include the following operations.

Operation S908. The target base station sends a third request message to the WT.

The third request message includes the first key and the third mobility set, and the third mobility set includes the identifier of the at least one third access point.

When the first request message may be the first WT addition request message, correspondingly, the third request message may be a first LWA modification request message.

Operation S909. The WT determines whether the third mobility set is the same as the first mobility set.

Operation S910. If the WT determines that the third mobility set is different from the first mobility set, the WT sends the first key to all third access points in the third mobility set.

Operation S911. The WT sends a third request acknowledgment message to the target base station.

The target base station receives the third request acknowledgment message sent by the WT.

When the third request message is an LWA modification request message, correspondingly, the third request acknowledgment message may be an LWA modification request acknowledgment message.

Operation S912. The target base station sends an RRC connection reconfiguration message to the user equipment.

The message carries the third mobility set and a parameter used to generate the first key.

The parameter used to generate the first key includes the WT counter value, or the WT counter value and the private information.

Operation S913. The target base station receives an RRC connection reconfiguration complete message sent by the user equipment.

### Embodiment 9

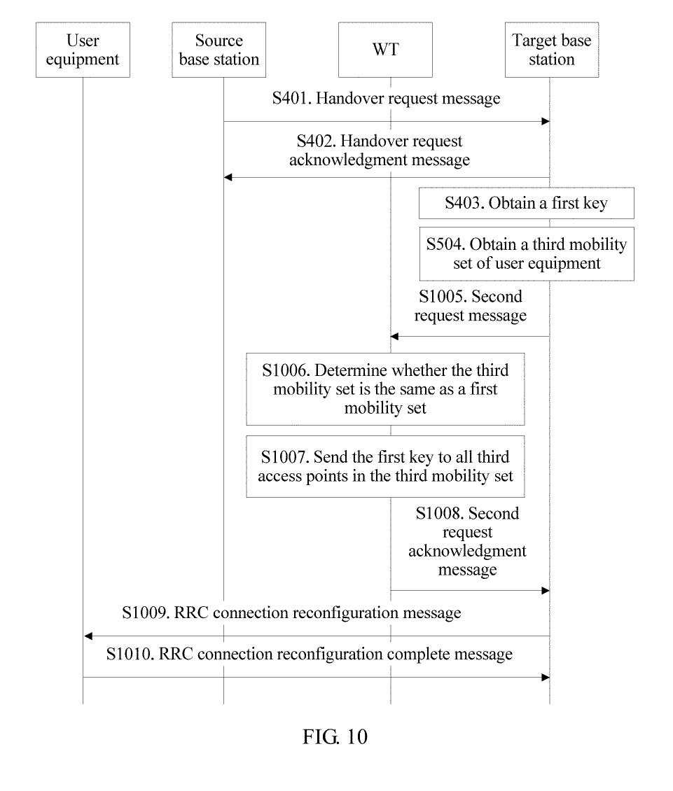

Embodiment 9 is based on the foregoing Embodiment 1 to Embodiment 7. After the target base station sends the handover request acknowledgment message to the source base station, the method further includes S1005 to S1010. For example, based on the embodiment shown in FIG. 6, FIG. 10 is a schematic flowchart of Embodiment 9 of a handover method according to the present invention.

Operation S1005. The target base station sends a second request message to a WT.

The second request message includes the first key and the third mobility set.

The second request message may be a second WT addition request message.

Operation S1006: The WT determines whether the third mobility set is the same as the first mobility set.

Operation S1007: If the WT determines that the third mobility set is different from the first mobility set, the WT sends the first key to all third access points in the third mobility set.

Operation S1008. The WT sends a second request acknowledgment message to the target base station.

The target base station receives the second request acknowledgment message sent by the WT.

When the second request message is the second WT addition request message, correspondingly, the second request acknowledgment message is a second WT addition request acknowledgment message.

Operation S1009. The target base station sends an RRC connection reconfiguration message to the user equipment.

The message carries the third mobility set and a parameter used to generate the first key.

The parameter used to generate the first key includes the WT counter value, or the WT counter value and the private information.

Operation S1010. The target base station receives an RRC connection reconfiguration complete message sent by the user equipment.

### Embodiment 10 and Embodiment 11

Embodiment 10 is based on the embodiment shown in Embodiment 8 or Embodiment 9. Before the RRC connection reconfiguration message is sent to the user equipment, the method further includes the following operations.

Operation S1114. The target base station sends a path handover request message to an MME.

The target base station sends the path handover request message to the mobility management entity (MME).

Operation S1115. The target base station receives a path handover request acknowledgment message to the MME.

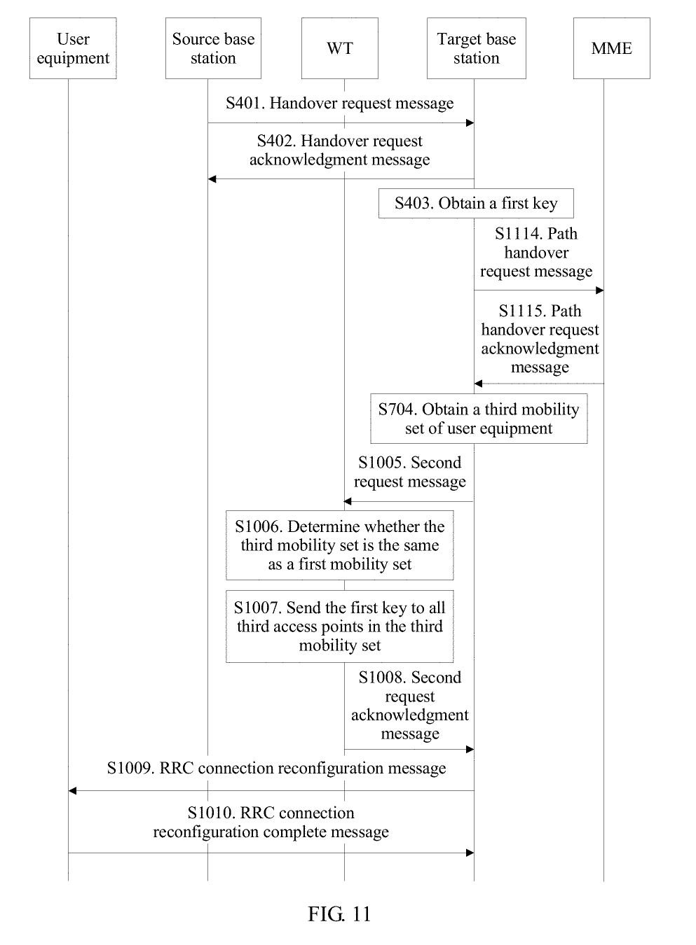

One possible implementation is shown in FIG. 11. FIG. 11 is a schematic flowchart of Embodiment 10 of a handover method according to the present invention. S1114 and S1115 are performed after the target base station sends the handover request acknowledgment message and before the third set of the user equipment is obtained.

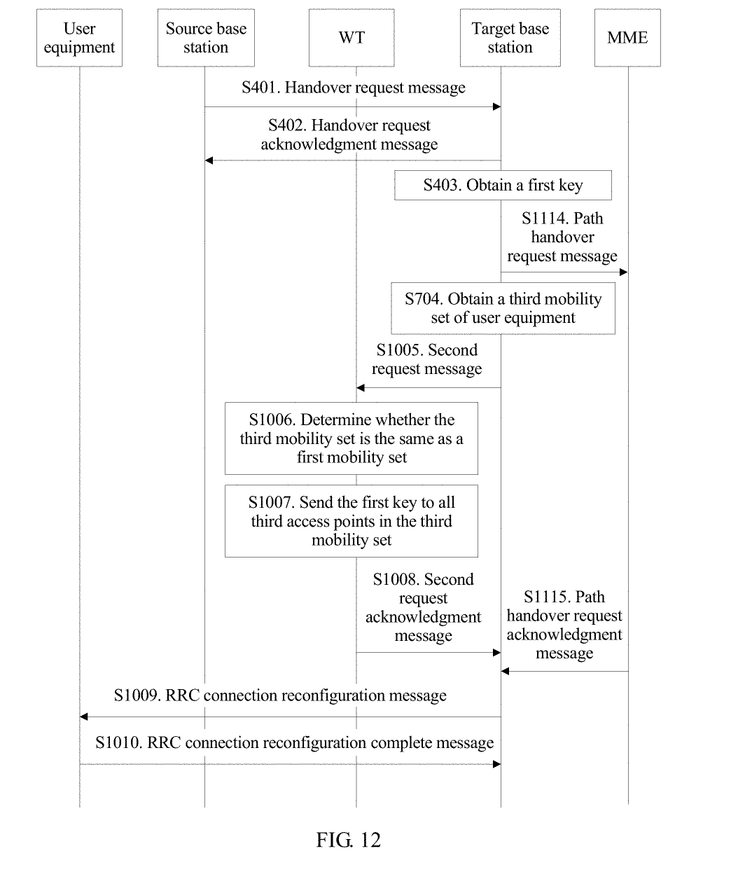

The other possible implementation is shown in FIG. 12. FIG. 12 is a schematic flowchart of Embodiment 11 of a handover method according to the present invention. Operation S1114 is performed before the third mobility set of the user equipment is obtained, and operation S1115 is performed after the second request acknowledgment message sent by the WT is received and before the RRC connection reconfiguration message is sent to the user equipment.

### Embodiment 12

In the foregoing embodiments, the handover request further includes an identifier of a fourth access point to which the user equipment is currently connected.

The determined third mobility set includes the identifier of the fourth access point, or the third mobility set does not include the identifier of the fourth access point.

### Embodiment 13

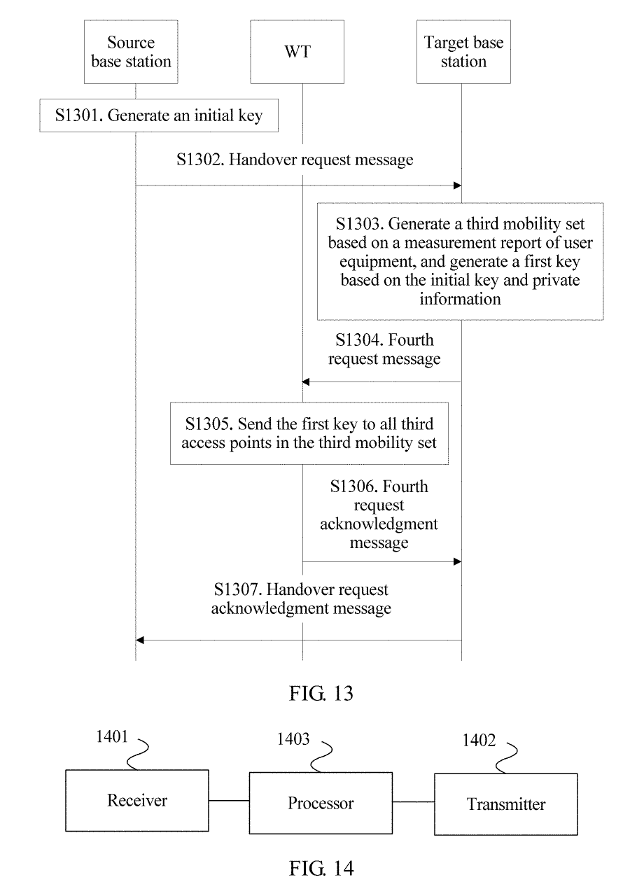

FIG. 13 is a schematic flowchart of Embodiment 13 of a handover method according to the present invention. The method in this embodiment is as follows.

Operation S1301. A source base station generates an initial key.

Operation S1302. The source base station sends a handover request message to a target base station.

The handover request message carries an identifier of user equipment, a first mobility set, a measurement report of the user equipment, and an identifier of a fourth access point to which the user equipment is currently connected.

Operation S1303. The target base station generates a third mobility set based on a measurement report of user equipment, and generates a first key based on the initial key and private information.

Operation S1304. The target base station sends a fourth request message to a WT.

The fourth request message includes the identifier of the user equipment, the first mobility set, the third mobility set, the first key, and the identifier of the fourth access point.

After receiving the fourth request message, the WT detects the first mobility set, and then determines to maintain a first connection; or detects the third mobility set, and then determines to perform operation S1305.

Operation S1305. The WT sends the first key to all access points in the third mobility set.

Operation S1306. The WT sends a fourth request acknowledgment message to the target base station.

Operation S1307. The target base station sends a handover request acknowledgment message to the source base station.

The operations involved in this embodiment of the present invention are steps related to improvement of the present invention. For ease of description, another operation in a handover procedure is not shown in the present invention.

FIG. 14 is a schematic structural diagram of Embodiment 1 of a handover apparatus according to the present invention. The apparatus in this embodiment is deployed in a target base station. As shown in FIG. 14, the apparatus in this embodiment includes a receiver 1401 and a transmitter 1402.

The receiver 1401 is configured to receive a handover request message sent by a source base station, where the handover request message includes first indication information, and the first indication information is used to indicate that user equipment is using a first connection.

The transmitter 1402 is configured to send a handover request acknowledgment message to the source base station, where the handover request acknowledgment message includes second indication information, and the second indication information is used to indicate that the first connection is maintained.

In the foregoing embodiment, the first indication information is an identifier of the user equipment and a first mobility set, and the first mobility set includes an identifier of at least one first access point.

In the foregoing embodiment, the first indication information is an identifier indicating that the user equipment is using the first connection.

In the foregoing embodiment, the second indication information is an identifier indicating that the first connection is maintained.

In the foregoing embodiment, the second indication information is the identifier of the user equipment and the first mobility set.

In the foregoing embodiment, the identifier of the user equipment is a Medium Access Control address.

In the foregoing embodiment, the first connection is a Long Term Evolution wireless local area network aggregation connection.

In the foregoing embodiment, the apparatus further includes a processor 1403, where the processor 1403 is configured to obtain a first key.

In the foregoing embodiment, the processor 1403 is further configured to obtain a third mobility set of the user equipment, where the third mobility set is determined based on a measurement report of the user equipment, and the third mobility set includes an identifier of at least one third access point.

In the foregoing embodiment, the processor 1403 is configured to generate the first key based on a second key and a WT counter value that are shared by the target base station and the user equipment.

In the foregoing embodiment, the processor 1403 is configured to obtain the third mobility set of the user equipment based on a measurement report of the user equipment.

In the foregoing embodiment, the transmitter 1402 is further configured to send a first request message to a WT, where the first request message includes third indication information, and the third indication information is used to indicate whether the WT maintains the first connection.

In the foregoing embodiment, the transmitter 1402 is further configured to send a second request message to the WT, where the second request message includes the first key and the third mobility set.

The receiver 1401 is further configured to receive a second request acknowledgment message sent by the WT.

The transmitter 1402 is further configured to send a radio resource control RRC connection reconfiguration message to the user equipment, where the message carries the third mobility set and a parameter used to generate the first key.

The receiver 1401 is further configured to receive an RRC connection reconfiguration complete message sent by the user equipment.

In the foregoing embodiment, the transmitter 1402 is further configured to send a third request message to the WT, where the third request message includes a first key and a third mobility set, and the third mobility set includes an identifier of at least one third access point.

The receiver 1401 is further configured to receive a third request acknowledgment message sent by the WT.

The transmitter 1402 is further configured to send an RRC connection reconfiguration message to the user equipment, where the message carries the third mobility set and a parameter used to generate the first key.

The receiver 1401 is further configured to receive an RRC connection reconfiguration complete message sent by the user equipment.

In the foregoing embodiment, the transmitter 1402 is further configured to send a path handover request message to a mobility management entity MME.

The receiver 1401 is further configured to receive a path handover request acknowledgment message sent by the MME.

In the foregoing embodiment, the transmitter 1402 is further configured to send a path handover request message to a mobility management entity MME.

The receiver 1401 is further configured to receive a path handover request acknowledgment message sent by the MME.

In the foregoing embodiment, the receiver 1401 is further configured to receive a handover determining message sent by the user equipment.

The transmitter 1402 is further configured to send a path handover request message to a mobility management entity MME.

The receiver 1401 is further configured to receive a path handover request acknowledgment message sent by the MME.

In the foregoing embodiment, the processor 1403 is configured to control the receiver to receive the first key sent by the source base station.

In the foregoing embodiment, the handover request message further includes the measurement report of the user equipment.

In the foregoing embodiment, the handover request message further includes an identifier of a fourth access point to which the user equipment is currently connected.

In the foregoing embodiment, the third mobility set includes the identifier of the fourth access point; or

the third mobility set does not include the identifier of the fourth access point.

In the foregoing embodiment, the handover request message further includes the third mobility set.

The processor 1403 is configured to obtain the third mobility set of the user equipment from the handover request message.

In the foregoing embodiment, the processor 1403 is configured to generate the first key based on a second key, a WT counter value, and private information that are shared by the target base station and the user equipment.

In the foregoing embodiment, the processor 1403 is configured to: control the receiver to receive an initial key sent by the source base station; and generate the first key based on the initial key and the private information.

In the foregoing embodiment, the third indication information includes the identifier of the user equipment and a second mobility set.

In the foregoing embodiment, the third indication information is an identifier indicating that the first connection is maintained.

The apparatus embodiment may be correspondingly used to execute the technical solution executed by the target base station in any method embodiment shown in Embodiment 2 to Embodiment 13. An implementation principle and a technical effect of the apparatus embodiment are similar to those of the technical solutions, and details are not described herein again.

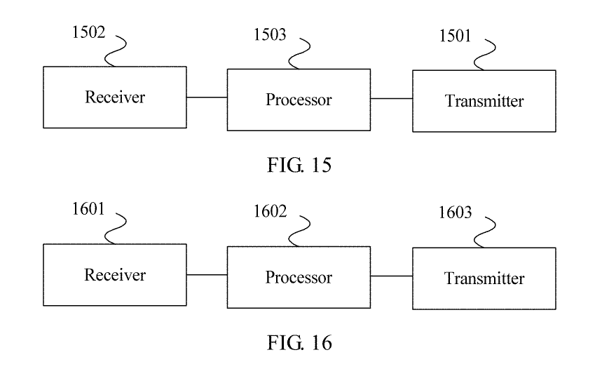

FIG. 15 is a schematic structural diagram of Embodiment 2 of a handover apparatus according to the present invention. The apparatus in this embodiment is deployed in a source base station. The apparatus in this embodiment includes a transmitter 1501 and a receiver 1502. The transmitter 1501 is configured to send a handover request message to a target base station, where the handover request message includes first indication information, and the first indication information is used to indicate that user equipment is using a first connection.

The receiver 1502 is configured to receive a handover request acknowledgment message sent by the target base station, where the handover request acknowledgment message includes second indication information, and the second indication information is used to indicate that the first connection is maintained.

In the foregoing embodiment, the first indication information is an identifier of the user equipment and a first mobility set, and the first mobility set includes an identifier of at least one first access point.

In the foregoing embodiment, the first indication information is an identifier indicating that the user equipment is using the first connection.

In the foregoing embodiment, the second indication information is an identifier indicating that the first connection is maintained.

In the foregoing embodiment, the second indication information is the identifier of the user equipment and the first mobility set.

In the foregoing embodiment, the identifier of the user equipment is a Medium Access Control address.

In the foregoing embodiment, the first connection is a Long Term Evolution wireless local area network aggregation connection.

In the foregoing embodiment, the transmitter is further configured to send a measurement report of the user equipment to the target base station.

In the foregoing embodiment, the handover request message further includes a third mobility set.

The apparatus further includes a processor 1503.

The processor 1503 is configured to generate the third mobility set based on a measurement report of the user equipment.

The apparatus embodiment may be correspondingly used to execute the technical solution executed by the source base station in any method embodiment shown in Embodiment 2 to Embodiment 13. An implementation principle and a technical effect of the apparatus embodiment are similar to those of the technical solutions, and details are not described herein again.

FIG. 16 is a schematic structural diagram of Embodiment 3 of a handover apparatus according to the present invention. The apparatus in this embodiment is deployed in a WT. The apparatus in this embodiment includes a receiver 1601 and a processor 1602. The receiver 1601 is configured to receive a first request message sent by a target base station, where the first request message includes third indication information, and the third indication information is used to indicate whether the WT maintains the first connection. The processor 1602 is configured to determine, based on the third indication information, whether to maintain the first connection.

In the foregoing embodiment, the third indication information includes an identifier of the user equipment and a second mobility set, and the second mobility set includes an identifier of at least one second access point.

In the foregoing embodiment, the third indication information is an identifier indicating that the first connection is maintained.

In the foregoing embodiment, the processor 1602 is configured to: if the second mobility set is the same as a first mobility set, determine to maintain the first connection, where the first mobility set includes an identifier of at least one first access point.

In the foregoing embodiment, the receiver 1601 is further configured to receive a third request message sent by the target base station, where the third request message includes a first key and a third mobility set, and the third mobility set includes an identifier of at least one third access point.

The processor 1602 is further configured to determine whether the third mobility set is the same as the first mobility set.

The apparatus further includes a transmitter 1603.

The transmitter 1603 is configured to: if the third mobility set is different from the first mobility set, send the first key to all third access points in the third mobility set.

The transmitter is further configured to send a third request acknowledgment message to the target base station.

The apparatus embodiment may be correspondingly used to execute the technical solution executed by the WT in any method embodiment shown in Embodiment 2 to Embodiment 13. An implementation principle and a technical effect of the apparatus embodiment are similar to those of the technical solutions, and details are not described herein again.

Persons of ordinary skill in the art may understand that all or some of the operations of the method embodiments may be implemented by a program instructing relevant hardware. The program may be stored in a computer-readable storage medium. When the program runs, the operations of the method embodiments are performed. The foregoing storage medium includes any medium that can store program code, such as a ROM, a RAM, a magnetic disk, or an optical disc.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A handover method, comprising:
receiving a handover request message from a source base station, wherein the handover request message comprises first indication information to indicate that user equipment is using a first connection; and
sending a handover request acknowledgment message to the source base station, wherein the handover request acknowledgment message comprises second indication information to indicate that the first connection is maintained.

2. The method according to claim 1, wherein the first indication information comprises an identifier of the user equipment and a first mobility set, and the first mobility set comprises an identifier of at least one first access point.

3. The method according to claim 1, wherein the first indication information includes an identifier indicating that the user equipment is using the first connection.

4. The method according to claim 1, wherein the second indication information includes an identifier indicating that the first connection is maintained.

5. The method according to claim 2, wherein the second indication information includes the identifier of the user equipment and the first mobility set.

6. The method according to claim 2, wherein the identifier of the user equipment includes a Medium Access Control address.

7. The method according to claim 1, wherein the first connection is a Long Term Evolution wireless local area network aggregation connection.

8. The method according to claim 1, wherein before sending a handover request acknowledgment message to the source base station, the method further comprises:
obtaining a first key.

9. The method according to claim 1, wherein after sending a handover request acknowledgment message to the source base station, the method further comprises:
obtaining a first key.

10. The method according to claim 8, wherein
after sending a handover request acknowledgment message to the source base station, the method further comprises:
obtaining a third mobility set of the user equipment.

11. The method according to claim 8, wherein the obtaining a first key comprises:
generating the first key based on a second key and a wireless local area network termination (WT) counter value that are shared by a target base station and the user equipment.

12. A handover apparatus, comprising:
a receiver configured to receive a handover request message from a source base station, wherein the handover request message comprises first indication information to indicate that user equipment is using a first connection; and
a transmitter configured to send a handover request acknowledgment message to the source base station, wherein the handover request acknowledgment message comprises second indication information to indicate that the first connection is maintained.

13. The apparatus according to claim 12, wherein the first indication information includes an identifier of the user equipment and a first mobility set, and the first mobility set comprises an identifier of at least one first access point.

14. The apparatus according to claim 12, wherein the processor is configured to obtain a first key.

15. The apparatus according to claim 14, wherein
the processor is further configured to obtain a third mobility set of the user equipment.

16. The apparatus according to claim 14, wherein the processor is configured to generate the first key based on a second key and a wireless local area network termination (WT) counter value that are shared by a target base station and the user equipment.

17. The apparatus according to claim 15, wherein the processor is configured to:
obtain the third mobility set of the user equipment based on a measurement report of the user equipment.

18. The apparatus according to claim 13, wherein the transmitter is further configured to send a first request message to a WT, the first request message comprises third indication information to indicate whether the WT maintains the first connection.

19. The apparatus according to claim 15, wherein the transmitter is further configured to send a second request message to the WT, and the second request message comprises the first key and the third mobility set;
the receiver is further configured to receive a second request acknowledgment message sent by the WT;
the transmitter is further configured to send a radio resource control (RRC) connection reconfiguration message to the user equipment, wherein the RRC connection reconfiguration message includes the third mobility set and a parameter used to generate the first key; and
the receiver is further configured to receive an RRC connection reconfiguration complete message from the user equipment.

20. A handover apparatus, comprising:
a receiver configured to receive a first request message from a target base station, wherein the first request message comprises third indication information to indicate whether the WT maintains the first connection; and
a processor configured to determine, based on the third indication information, whether to maintain the first connection.
